(19) United States
(12) Patent Application Publication
(10) Pub. No.: US 2007/0136467 A1
(43) Pub. Date: Jun. 14, 2007

(54) Device Substitution

(76) Inventors: Joseph M. Masci, Thousand Oaks, CA (US); Paul G. Lupo, Oxnard, CA (US); Athar A. Muzaffar, Thousand Oaks, CA (US)

Correspondence Address: SoCAL IP LAW GROUP LLP, 310 N. WESTLAKE BLVD. STE 120, WESTLAKE VILLAGE, CA, 91362, US

(21) Appl. No.: 11/567,697

(22) Filed: Dec. 6, 2006

Related U.S. Application Data
(60) Provisional application No. 60/742,957, filed on Dec. 6, 2005.

(51) Int. Cl. G06F 15/173

(52) U.S. Cl. 709/225

(57) ABSTRACT

There are disclosed systems and methods for managing network devices and/or physical layer devices involving a server computer, a client computer coupled with the server computer, and a connector device coupled with the server computer, and a plurality of network devices and/or physical layer devices coupled with the connector device. A management application executing on the server may provide a graphical user interface allowing for dynamic substitution of network devices and/or physical layer devices based on device substitution requirements provided by a user.

### RELATED APPLICATION INFORMATION

This patent application claims priority to provisional patent application No. 60/742,957 filed Dec. 6, 2005 and entitled Device Substitution, which is incorporated herein by reference in its entirety.

### NOTICE OF COPYRIGTHS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This patent application relates to network devices and monitoring, configuring and managing network devices in a lab, in a network and in network labs.

2. Description of the Related Art

Laboratories, test facilities, and network equipment facilities include many interconnected devices test that may be tested and accessed by various users such as testers. Laboratory enviromnents are frequently neither logical nor orderly and may be connect devices in a quite confusing tangle of cables and connectors. Terms like “rats' nest” or “spaghetti” are commonly used by laboratory users to describe messy laboratory arrangements and environments.

Test scripts which may be used on one device are not typically usable on other devices. Further, when a test needs to be re-created, a significant amount of time may be spent attempting to re-create the test environment, connections and conditions.

The manual interconnection and operation of devices is often conducted by selecting and plugging in patch cables directly to devices or via cable patching systems. Sometimes it is not apparent what connections between devices are required or allowed, and incorrect cable selection and device connections often result. Further, because laboratories are often shared, it is not unusual for testers to encounter schedule conflicts over access to devices. Most laboratories do not have any kind of reservation system which results in a trial-and-error method of gathering devices for a particular test. This can result in equipment-hoarding behavior and low device utilization rates.

Documentation of test results is also a significant source of frustration and inefficiency. Testers often manually record the conditions and results in notebooks or on scraps of computer paper.

Test scripts which may be used on one device are not typically usable on other devices. Further, when a test needs to be re-created, a significant amount of time may be spent attempting to re-create the test environment, connections and conditions.

### DESCRIPTION OF THE DRAWINGS

FIG. 1 is a block diagram showing an example environment in which the management application software described herein may be used.

FIG. 2 is a block diagram showing a generalized environment in which the management application software may be used.

FIG. 3 is a screen shot of the main window of a management application software described herein.

FIG. 4 is a portion of a screen shot showing a use case and a user interface for an embodiment of device substitution as provided by the management application software described herein.

### DETAILED DESCRIPTION

Throughout this description, the embodiments and examples shown should be considered as exemplars, rather than limitations on the systems and methods disclosed or claimed.

Environment

The systems and methods described herein include a management application that provides automated re-configurations, asset management, and remote access to network devices in a lab, network lab or other network.

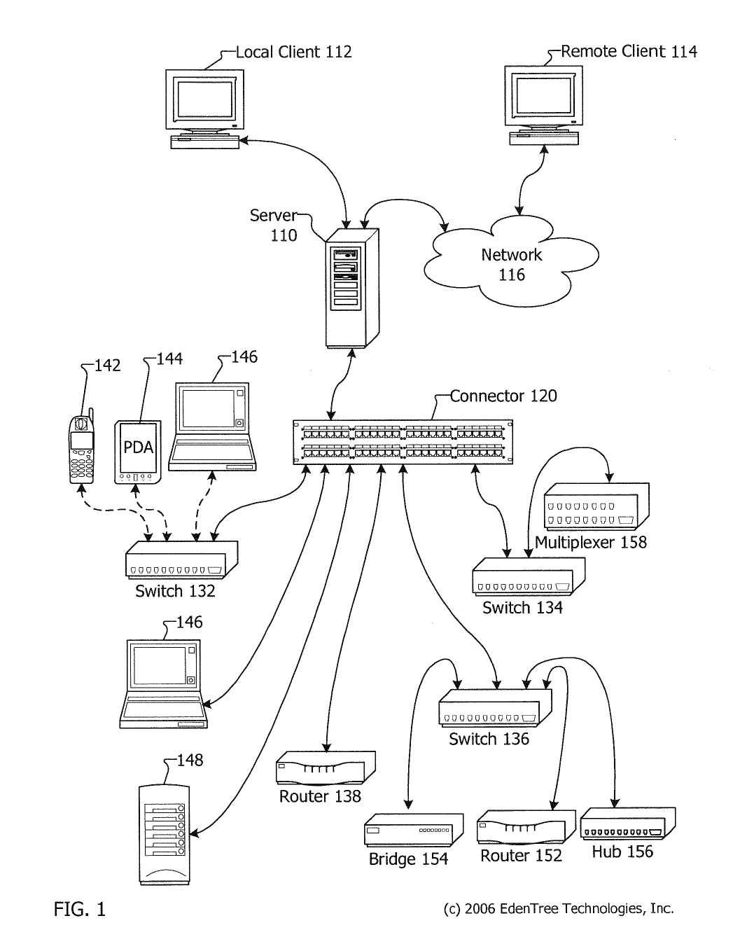

FIG. 1 is a block diagram showing an example environment 100 in which the management application may be used. In the example environment 100, the management application is software that is stored on and executed by server 110. A user may access the management application from local and/or remote client devices such as local client 112 and remote client 114. The local client 112 may be coupled directly with the server 110 or through a local network (not shown). The remote client 114 may be coupled directly with the server 110 or through a network 116. A user from another building, town, city, state or half way across the world may access the features of the management application on server 110 through remote client 114. The local client 112 and remote client 114 are typically personal computers, computer workstations, and laptop computers and may be other computing devices, as defined below. Although only one each of local client 112 and remote client 114 are shown, the methods and systems described herein may be used with multiple local clients 112 and remote clients 114. The server 110 is coupled to connector device 120.

The management application provides for application management of physical layer switches and/or other switches 132, 134 and 136. The term “physical layer” refers to layer 1 of the Open System Interconnection (OI) model of network communication protocols. The management application permits sharing of network devices among multiple users, resulting in increased usage. The management application may contribute to or cause a reduction in wasted time and inefficiencies associated with manual tracking, patching and equipment reconfiguration involving the network devices. In a lab testing configuration, the management application may result in reduced time-to-market for a network device under test.

The term “computing device” as used herein refers to any device with a processor, memory and a storage device that may execute instructions including, but not limited to, personal computers, server computers, computing tablets, personal digital assistants (PDAs), cellular telephones, portable computers, and laptop computers. These computing devices may run an operating system, including, for example, variations of the Linux, Unix, Solaris, MS-DOS, Microsoft Windows, Palm OS, Symbian, and Apple Mac OS X operating systems.

Referring again to FIG. 1, the configuration of network devices shown does not represent a typical selection and arrangement of network devices used with the management application. Rather, FIG. 1 shows some of the network devices that may be used with the management application that executes on server 110. Various network devices may be coupled with the connector device 120. Connector device 120 may be a patch bay, a physical layer switch, an optical switch, and others. In one configuration, connector device 120 is a Media Cross Connect device from MRV Communications of Chatsworth, Calif. The connector device 120 may be a switch available from Apcon, Calient, Continuum Photonics, Curtiss-Wright, Cytec, Eastern Research, Glimmerglass Networks, Lynx, Polatis, Racal Instruments, Universal Switching, and others. Multiple switches from multiple manufacturers may be transparently managed simultaneously from one single server application running on the server 110, referred to herein as the management application, while a user accesses a client application on a client device 112 and 114 to manage and control the functioning of network devices coupled with the connector device 120 via the management application.

The management application may provide a graphical user interface to its functionality directly and/or through the client application. In one embodiment the client application is an Internet browser on a client computer that accesses the management application on the server computer. Example Internet browsers include Firefox, Microsoft Internet Explorer, Opera, Safari, and the like. In another embodiment, the client application is a software program provided by the same entity that provides the management application.

As shown in FIG. 1, the management application running on server 110 may allow for the control and management of various network devices that are coupled with the connector 120. As shown in FIG. 1, for example only, the network devices that may be coupled with connector device 120 may be one or more of each of switches 132 and 134, and 136. Other networking devices may be coupled with connector device 120. Other networking devices may be coupled with switches 132, 134 and 136. For example, one or more multiplexers 158 may be coupled with switch 134. Further, one or more of each of bridge 154, router 152 and hub 156 may be coupled with switch 136. In addition, various other network devices may be coupled with connector device 120, such as, for example, router 138, laptop computer 146 and network attached storage 148. A laptop computer 146, a PDA 144, a cellular telephone 142, and other computing devices as well as other network devices may be coupled with a switch 132 which is coupled with the connector device 132. The computing devices (the laptop computer 146, the PDA 144, the cellular telephone 142 and others) may be coupled with the switch 132 via wires and/or wirelessly.

The management application may run test cases on devices, including network devices. The management application may permit users to track device usage, behavior, and functioning. The management application may allow a user to apply stored configurations including recalling, scheduling, and sharing of stored configurations. The management application may provide automated re-configuration of devices. The management application may manage physical layer switches (for example, switches 132, 134 and 136 in FIG. 1) to which devices are connected.

Various and multiple network devices may be coupled to the connector device 120. As used herein the term “network device” means any device capable of communicating on a network. Network devices include routers, switches, hubs, firewalls, multiplexers, gateways, bridges, load balancers, printers, multi-function peripherals, network attached storage (NAS) devices, drive arrays, and computing devices. In addition, home appliances such as refrigerators, heating and air conditioning controllers and systems and other devices capable of network communication are within the definition of network devices used herein.

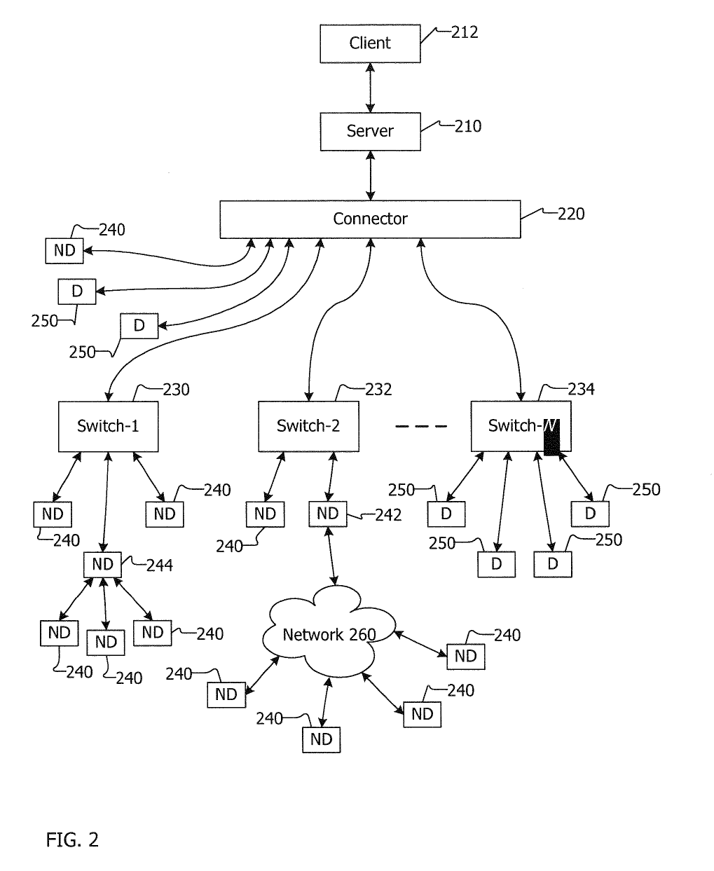

FIG. 2 is a block diagram showing a generalized environment 200 in which the management application software may be used. One or more clients 212, a computer or other computing device, may be coupled directly or via a network with, from a local or remote location, with a server 210 running the management application. The server may be coupled with a connector device 220. Multiple network devices 240 and physical layer devices 250 may be coupled directly with connector device 220. Physical layer devices 250 may be layer one physical layer devices that are not capable of network connections, such as, for example, signal generators. The network devices 240 may all be the same kind, type or model of network device or may be multiple different kinds, types or models of network devices. Multiple switches Switch-1 230, Switch-2 232 and Switch-3 234 may be coupled with connector device 220. In one embodiment, no network devices or other devices are coupled with the switches 230, 232 and 234. More typically, other network devices 240 and/or physical layer devices 250 are coupled with switches 230, 232 and 234, as shown. The network devices 240 may be coupled via wires or wirelessly with the switches 230, 232 and 234. Some of the network devices 242 coupled with switches such as Switch-2 232 may connect to a network 260 where other network devices 240 are coupled. For example, network device 242 may be a firewall, gateway, router, or other network device. Some of the network devices 244 coupled with switches such as Switch-1 230 may have network devices 240 coupled therewith. For example, network device 244 may be a firewall, gateway, router, or other network device.

The processes, functionality and features of the management application may be embodied in whole or in part in software which operates on a computer such as a server computer shown 110 and 210 in FIGS. 1 and 2. The management application may be an application program which may include source code and compiled source code in the form of libraries as well as plug-ins, and may also include firmware, one or more applets (e.g., a Java applet), a browser plug-in, a COM object, a dynamic linked library (DLL), a script, one or more subroutines, an operating system component or service. The management application and/or other software as well as the server and/or other hardware and their functions may be distributed such that some components are performed by one computer and others by other computers or computing devices. That is, although only one of each of server 110 and server 210 is shown in FIGS. 1 and 2, one or more servers 110 and 210 or combination of servers, devices and/or computing devices may be used.

The management application may be stored permanently or temporarily on a storage media which may be included in a storage device which may be included with or otherwise coupled or attached to the servers 110 and 210 or other computing device. These storage media include, for example, magnetic media such as hard disks, floppy disks and tape; optical media such as compact disks (CD-ROM and CD-RW) and digital versatile disks (DVD and DVD±RW); flash memory cards and devices (for example, thumb drives, SD memory cards, and others); and any other storage media. As used herein, a storage device is a device that allows for reading and/or writing to a storage medium. Storage devices include, hard disk drives, DVD drives, flash memory readers/writers, and others.

As used herein the term data unit shall mean a frame, cell, datagram, packet or other unit of information.

The Management Application

The management application provides automated configuration, asset management, and remote access for labs or other groups of network devices. The management application communicates with and controls various third-party physical layer switches. The term “physical layer” refers to layer 1 of the Open Systems Interconnection (OSI) model of the International Standards Organization (ISO). Using the management application allows for the elimination of wasted time and other inefficiencies associated with manual tracking, patching and equipment reconfiguration of multiple network devices in a lab or other environment.

The management application may include an internal scheduler to allow for the sharing of lab resources among multiple users. The management application allows test cases to be run with managed equipment and network devices. The management application may be integrated with third-party test management systems. The management application permits users to track lab resource usage, design and apply configurations from a computer desktop, and recall, schedule and share those configurations.

The management application may serve as a front-end system for multi-user, multi-vendor networking and lab environments. The functionality of the management application may be provided to a user directly and/or through a client application on a client computer. The management application provides automated re-configurations, secure remote presence, and asset management. The management application consists of a client/server application with a Graphical User Interface and may provide application programming interfaces (APIs) (which may be accessed using Tcl, Perl, and other scripting and compiled languages) to manage physical layer switches and other switches to which physical layer devices and network devices are connected. The management application allows for “hands-off” reconfigurations of lab network devices. The management application allows for improvements in efficiency, security, equipment availability and sharing, and/or asset tracking. The management application may particularly benefit networks or labs requiring sharing of network devices among multiple users, frequent re-configurations, test automation, asset tracking, and/or secure remote access to network device in a remote lab.

The management application may automate laboratories so that use of network devices is optimized among lab users. The management application may control third party physical layer switches to which network devices are connected. The management application may serve in some ways as a software-controlled patch panel that allows resources to be securely accessed, switched, reserved and controlled remotely. As shown above in FIGS. 1 and 2, network devices, also referred to as devices under test, are physically connected to one or more switches. The management application provides for configuration of the network devices, and configuration with a drag-and-drop graphical user interface (GUI) and/or automated scripts. The management application enables the sharing of network devices such as expensive test equipment and other lab resources, and increases test repeatability and consistency.

The management application may provide a GUI that allows a user to perform one or more of the following actions: search for available devices that have specific attributes; define generic configurations with device types that may be replaced with available network devices at a time of reservation; and assign domain rights to users to limit access privileges to certain network devices.

The management application may allow a user to track the utilization of network devices in a lab, whether connected through a switch or not. The management application may include a reservation system that allows multiple users to reserve network devices and their resources, down to the port level, and may automatically connect those ports.

The management application manages cross-connects or switches that interconnect network devices in a lab or other environment. The management application can manage virtual switching matrices of switches from disparate manufacturers while keeping the switching infrastructure transparent to the user of the management application.

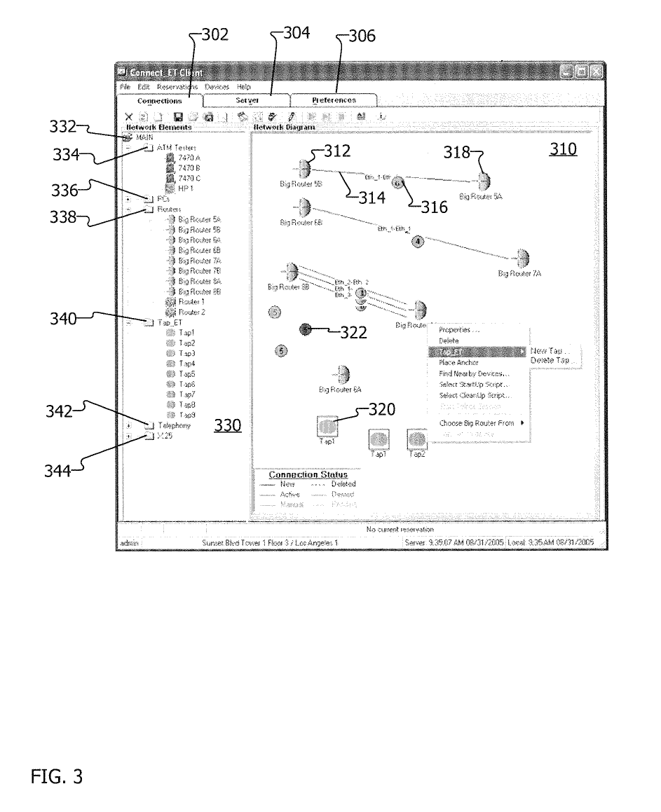

FIG. 3 shows a main window 300 of the management application and constituent panes and user interface items. The main window 300 may have three tabs, a connections tab 302, a server tab 304 and a preferences tab 306. The connections tab 302 allows for the presentation of a network diagram pane 310 and a network devices pane 330. The management application may provide a GUI that allows a user to drag and drop icons representing network devices to create usage cases which can be stored, re-used and shared for instant re-configuration and repeatability of testing. A usage case is an arrangement of network devices, taps (described below), and/or monitors (described below), as well as communication lines, other constructs and related configuration data. A test may be run on, over and/or through a use case. The management application allows a user to select a network device from the network devices pane 330 and drag the device to the network diagram pane 310 where a use case may be created. The management application may also make network devices and network elements available via a toolbar, tool pad and/or a pull down menu. The user may arrange network devices 312, 316 and 318 and connect them by dragging/drawing lines 314 between the network devices 312, 316 and 318. This may be achieved using a pencil tool or similar graphical user interface construct. The line may be an available communications medium, such as, for example, Ethernet, X.25, telephony, fiber optic and others, or may lines be within a switch Element 316 represents a tap (described below) as added to an existing connection.

The network device pane 330 may include various network devices arranged by category or type, as well as a listing of existing or available taps and communications media. In the example shown in FIG. 3, the network device pane 330 provided by the management application includes a main folder 332 of ATM testers 334, a folder of PCs 336, routers 338, taps 340, telephony devices, and X.25 devices. Other folders for other kinds, types, and classes of device may also be included in the network device pane 330.

A user may add taps 322 and monitors 320 to the use case. The management application may receive user selection and designation of taps and monitors. The management application may include a tap feature which enables tapping into existing connections between network devices in active use cases. Adding a tap 320 as tap 316 creates a duplicate of a data connection that can be sent to one or more monitors 322. If the duplicate is sent to multiple monitors, the result is effectively multicasting the original signal. In general, connections between network devices or ports of network devices are made in pairs, and any port can generate multicast communications traffic. The management application allows a user to listen on one side of an ongoing connection. Each end-point of a connection may send data units to a listening port. As such, two ports are used to listen to a full connection between two network devices. Analyzers may be inserted in a “thru” mode, meaning the original connection may be broken, and an analyzer with two full-duplex ports may be inserted between them. Alternatively, a full-duplex connection may be redirected from one endpoint to an analyzer instead of to its original target device.

The management application supports tapping into existing connections in active use cases using capabilities provided by some switch manufacturers. This is referred to herein as connection tapping. In general, connections are made in pairs: one network device transmits to another and receives from another. As such, a bi-directional connection includes two “listening” and two “transmitting” ports.

The management application includes to two GUI components that are used with connection tapping: taps and monitors. A tap is a GUI element that links to an existing connection and provides a virtual data source from the transmit port on a device. A monitor is a GUI element that is used to connect a tap to another device (for example, an analyzer) that will receive the transmitted data from a tapped connection. Usage cases may contain zero or more taps and zero or more monitors.

As used herein, a “tap” is a logical connection to a connection between two device ports. In various embodiments, taps may have a reference identifier (ID) which is <blank> or a user specified label, or may have the values 0-9, or other numerals or alphanumeric sequence. Each tap may be associated with zero or more “monitors” in a usage case. A “<blank>” tap is always considered a unique reference ID. Multiple “<blank>” taps may exist for a usage case. In one embodiment, each tap in a usage case has a unique reference ID. That is, more than one tap cannot have the same reference ID in a usage case. In this embodiment, a tap can have the same reference ID across different usage cases. For example, tap 0 for usage case 1 may be different from tap 0 for usage case 3. In one embodiment, the management application does not support taps for manual connections. As such, in this embodiment, the GUI does permit the creation of taps for manual connections.

As used herein, a “monitor” is a logical endpoint for a tap. Each monitor is a “virtual device” that other devices in a usage case connect to. Monitors can have a value of <blank> or can be associated with tapped connections by using the tap's associated reference number (0-9). Monitors are associated with a “tap” with the same reference ID. For example, monitor 3 is logically associated with tap 3 in a particular usage case. More than one monitor may have the same reference ID in a usage case. When more than one monitor has the same reference number in a usage case a multicast results. There is no limit to the number of monitors that share a reference ID, although some switches may impose an upper limit. When that upper limit is met or exceeded, the limit may be displayed during a reservation request and/or a failure notification may be provided via a display, audible notification or other alert as a failed connection. A monitor may be connected to another monitor. In another embodiment, the management application does not support connecting one monitor device to another. As such, in this embodiment, the GUI of the management application does permit the connection.

In one embodiment, the management application does not allow for tapping the connection between a monitor and a network device. As such, the GUI of the management application does permit the tap creation.

In some situations, a user of the management application may deem it be beneficial to specify a device by type while leaving explicit device selection to be performed at a user specified reservation time from a group of equivalent devices. The selection at the specified reservation time may be achieved based on availability, user specified requirements, including connectivity requirements. The technique of management application reservation time device selection based on availability of a device meeting user specified requirements is referred to herein as dynamic device substitution. Using dynamic device substitution, the management application may select devices by comparing user specified device requirements with inventory availability. Use of dynamic device substitution may increase device utilization by reducing device conflicts.

Dynamic device substitution may support the simultaneous reservation of the same usage case by many users. This may be achieved by the management application automatically substituting equivalent devices from inventory according to user specified dynamic device substitution requirements.

When obtaining information device substitution requirements, the management application may allow a user to specify information, including one or more of the following, for example, a device type, device properties, a specified time and a specified time period. The device type may correspond to one or more of the device types listed in pane 330 under the main folder 332. The device properties that may be selected may vary in part based on the device type. The device properties may include a communication speed, layers of service, protocols supported, number of ports, quality or level of service, location of the device, and others. A specified time and a specified time period are optional. In some circumstances, there is no start time and no specified time. In these circumstances the management application may provide a dynamic substitution when the user elects by user activation to view current communication in the particular use case. This may be when performing real-time monitoring or viewing.

Dynamic device substitution may allow for device compartmentalization in a hierarchy that mirrors a lab or organizational structure specified by a management application user, such as an administrator. The management application may provide a user the ability to specify a hierarchy in a dynamic device substitution properties page, or may allow a user to specify a hierarchy in a use case. The specified hierarchy may be used during automated selection during dynamic device substitution by the management application to narrow the range of devices that may be selected. In one embodiment, the management application examines the hierarchy in a bottom-up manner.

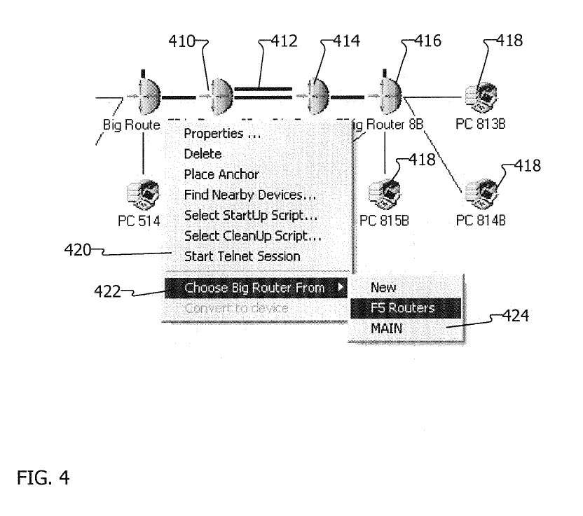

Referring now to FIG. 4, FIG. 4 is a portion of a screen shot showing a use case 400 and a user interface for an embodiment of device substitution as provided by the management application software described herein. The management application may provide a pull down menu 420 or other user interface construct to allow a user to select a device type to use for dynamic device substitution from available devices. The available devices may be those shown in network device pane 330 or in another device folder or list. To reach this menu, the management application may receive a user right-click on a device in a use case. The management application may then provide a menu item 422 that allows a user to select “Choose <device name> from . . . ” to invoke dynamic device substitution. The <device name> may be the name of the device selected. Selecting the “Choose <device name> from . . . ” 422 menu entry displays a folder listing of available device types, kinds, and/or areas as configured by a management application. The example shown in FIG. 4 is based on PCs organized in the “Main” folder 332 in addition to a “PCs” folder 336. In the user selects “Main” 424, a further menu showing all of available device types, classes, and/or kinds shown in “Main” folder 332.

When a user selects the “PCs” folder, the management application will receive the selection and search for an equivalent device from devices listed in the “PCs” folder 336 in network device pane 330. The management application may store the user selection in a substitution repository and may save the selection as part of the particular usage case.

The management application may work in conjunction with a client application so that the client application displays the name for a device the management application selected at reservation time that conforms or meets the dynamic user specified dynamic substitution requirements. The usage case may operate on the management application selected reservation time device as if it were a non-dynamic substitution device.

The management application returns device names to the folder name selection when a reserved use ceases to indicate that the device is available. The management application changes the generic type of device name shown in a use case to a specific device name when a reserved use begins. The management application changes device names to the type name when a reserved use ceases.

Devices chosen by the management application at reservation time may be different due to device availability constraints.

Closing Comments

The foregoing is merely illustrative and not limiting, having been presented by way of example only. Although examples have been shown and described, it will be apparent to those having ordinary skill in the art that changes, modifications, and/or alterations may be made.

Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or farther refined to achieve the methods described herein. Acts, elements and features discussed only in connection with one embodiment are not intended to be excluded from a similar role in other embodiments.

As used herein, whether in the written description or the claims, “plurality” means two or more.

As used herein, whether in the written description or the claims, a “set” of items may include one or more of such items.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims.

As used herein, “and/or” means that the listed items are alternatives, but the alternatives also include any combination of the listed items.

It is claimed:

1. A system for managing devices comprising:
a server computer;
a connector device coupled with the server computer;
a plurality of network devices and/or physical layer devices coupled with the connector device;
a management application program stored on the server computer, the management application program providing a graphical user interface and configured to
receive network device configuration information describing an arrangement of some of the plurality of network devices and/or physical layer devices,
receive a device reservation request specifying device substitution requirements,
wherein the device substitution requirements include one or more of a device type, device properties, a specified time and a specified time period,
reserve a selected device from a group of devices of the type of device specified in the device substitution requirements.

2. The system of claim 1 wherein to reserve the selected device is based on which of the group of devices best meets the device reservation requirements.

3. The system of claim 2 wherein the selected device is one of the devices that is available at the specified time for the specified time period.

4. The system of claim 2 wherein the selected device has properties that correspond to or exceed the device properties specified in the device substitution requirements.

5. The system of claim 1 wherein the management application is configured to reserve when the specified time is reached.

6. The system of claim 1 wherein the management application is configured to reserve when a user activation is received.

7. A method for managing network devices involving a server computer, a client computer coupled with the server computer, and a connector device coupled with the server computer, the method comprising:
coupling a plurality of network devices and/or physical layer devices with the connector device;
receiving via a management application program stored on the server computer network device configuration information describing an arrangement of some of the plurality of network devices;
receiving a device reservation request specifying device substitution requirements, wherein the device substitution requirements include one or more of a device type, device properties, a specified time and a specified time period;
reserving a selected device from a group of devices of the type of device specified in the device substitution requirements.

8. The method of claim 7 wherein the reserving the selected device is based on which of the group of devices best meets the device reservation requirements.

9. The method of claim 8 wherein the reserving the selected device is based on which of the devices is available at the specified time for the specified time period.

10. The method of claim 8 wherein the selected device has properties that correspond to or exceed the device properties specified in the device substitution requirements.

11. The method of claim 8 wherein the reserving is performed when the specified time is reached.

12. The method of claim 8 wherein the reserving is performed when a user activation is received.

13. A storage medium having instructions for managing network devices and/or physical layer devices stored thereon which when executed by a server computer having a connector device coupled therewith, the connector device having a plurality of network devices and/or physical layer devices coupled therewith, cause the server computer to perform actions comprising:
receiving device configuration information describing an arrangement of some of the plurality of network devices and/or physical layer devices;
receiving a device reservation request specifying device substitution requirements, wherein the device substitution requirements include one or more of a device type, device properties, a specified time and a specified time period;
reserving a selected device from a group of devices of the type of device specified in the device substitution requirements.

14. The storage medium of claim 13 wherein the reserving the selected device is based on which device of the group of devices best meets the device reservation requirements.

15. The storage medium of claim 13 wherein the selected device is one of the devices that is available at the specified time for the specified time period.

16. The storage medium of claim 13 wherein the selected device has properties that correspond to or exceed the device properties specified in the device substitution requirements.

17. The storage medium of claim 13 wherein the reserving is performed when the specified time is reached.

18. The storage medium of claim 13 wherein the reserving is performed when a user activation is received.
